(19) United States
(12) Patent Application Publication
(10) Pub. No.: US 2006/0110014 A1
(43) Pub. Date: May 25, 2006

(54) Expression invariant face recognition

(75) Inventors: Vasanth Philomin, Stolberg (DE); Srinivas Guita, Eindhoven (NL); Miroslav Trajkovic, Coram, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/538,093

(22) PCT Filed: Dec. 10, 2003
(86) PCT No.: PCT/IB03/05872

§ 371 Date: Jun. 8, 2005

Related U.S. Application Data
(60) Provisional application No. 60/433,374, filed on Dec. 13, 2002.

(51) Int. Cl. G06K 9/00; G06K 9/46; G06K 9/62

(52) U.S. Cl. 382/118; 382/190; 382/209

(57) ABSTRACT

An identification and/or verification system which has improved accuracy when the expression on the face of the captured image is different than the expression on the face of the stored image. One or more images of a person are captured. The expressive facial features of the captured image are located. The system then compares the expressive facial features to the expressive facial features of the stored image. If there is no match then the locations of the non-matching expressive facial feature in the captured image are stored. These locations are then removed from the overall comparison between the captured image and the stored image. Removing these locations from the subsequent comparison of the entire image reduces false negatives that result from a difference in the facial expressions of the captured image and a matching stored image.

### FIELD OF THE INVENTION

The invention relates in general to face recognition and in particular to improved face recognition technology which can recognize an image of a person even if the expression of the person is different in the captured image than the stored image.

### BACKGROUND OF THE INVENTION

Face recognition systems are used for the identification and verification of individuals for many different applications such as gaining entry to secure facilities, recognizing people to personalize services such as in a home network environment, and locating wanted individuals in public facilities. The ultimate goal in the design of any face recognition system is to achieve the best possible classification (predictive) performance. Depending on the use of the face recognition system it may be more or less important to make sure that the comparison has a high degree of accuracy. In high security applications and for identifying wanted individuals, it is very important that identification is achieved regardless of minor differences in the captured image vs. the stored image.

The process of face recognition typically requires the capture of an image, or multiple images of a person, processing the image(s) and then comparing the processed image with stored images. If there is a positive match between a stored image and the captured image the identity of the individual can either be found or verified. From hereon the term “match” does not necessarily mean an exact match but a probability that a person shown in a stored image is the same as the person or object in the captured image. U.S. Pat. No. 6,292,575 describes such a system and is hereby incorporated by reference.

The stored images are typically stored in the form of face models by passing the image through some sort of classifier, one of which is described in U.S. patent application Ser. No. 09/794,443 hereby incorporated by reference, in which several images are passed through a neural network and facial objects (e.g. eyes, nose, mouth) are classified. A face model image is then built and stored for subsequent comparison to a face model of a captured image.

Many systems require that the alignment of the face of the individual in the captured image be controlled to some degree to insure the accuracy of the comparison to the stored images. In addition many systems control the lighting of the captured image to insure that the lighting will be similar to the lighting of the stored images. Once the individual is positioned properly the camera takes a single or multiple pictures of the person, builds a face model and a comparison is made to stored face models.

A problem with these systems is that the expression on the person's face may be different in the captured image than in the stored image. A person may be smiling in the stored image, but not in the captured image or a person may be wearing glasses in the stored image and contacts in the captured image. This leads to inaccuracies in the matching of the captured image with the stored image and may result in misidentification of an individual.

### SUMMARY OF THE INVENTION

Accordingly it is an object of this invention to provide an identification and/or verification system which has improved accuracy when the expressive features on the face of the captured image are different than the expressive features on the face of the stored image.

The system in accordance with a preferred embodiment of the invention captures an image or multiple images of a person. It then locates the expressive facial features of the captured image, compares the expressive facial features to the expressive facial features of the stored images. If there is no match then the coordinates of the non-matching expressive facial feature in the captured image are marked and/or stored. The pixels within these coordinates are then removed from the overall comparison between the captured image and the stored image. Removing these pixels from the subsequent comparison of the entire image reduces false negatives that result from a difference in the facial expressions of the captured image and a matching stored image.

Other objects and advantages will be obvious in light of the specification and claims.

### BRIEF DESCRIPTION OF THE DRAWINGS

For a better understanding of the invention reference is made to the following drawings:

FIG. 1 shows images of a person with different facial expressions.

FIG. 2a shows a facial feature locator.

FIG. 2b shows a facial image with locations of expressive facial features.

FIG. 3 shows a preferred embodiment of the invention.

FIG. 4 is a flow chart of a preferred embodiment of the invention.

FIG. 5 shows a diagrammatic representation of the comparison of an expressive feature.

FIG. 6 shows an in-home networking facial identification system in accordance with the invention.

### DETAILED DESCRIPTION OF THE PREFERRED EMBODIMENT

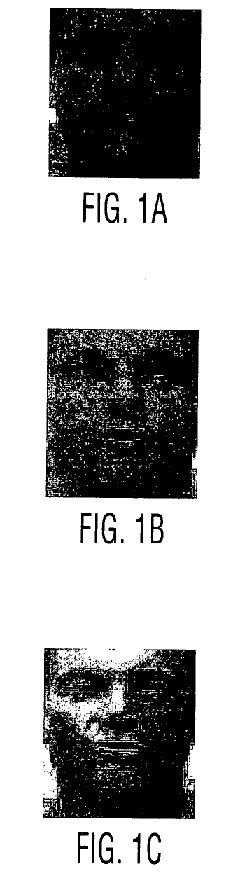

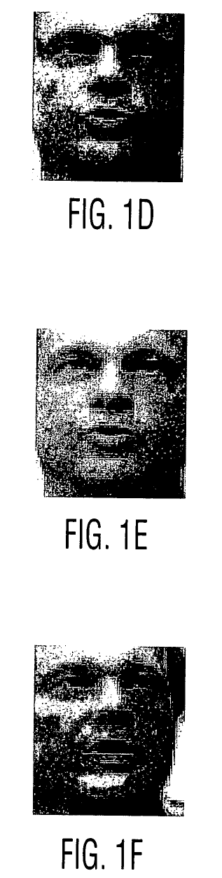

FIG. 1 shows an exemplary sequence of six images of a person with changing facial expressions. Image (a) is the stored image. The face has very little facial expression and it is centered in the picture. Images (b)-(f) are captured images. These images have varying facial expressions and some are not centered in the picture. If the images (b-f) are compared to the stored image(a) a positive identification may not be found due to the differing facial expressions.

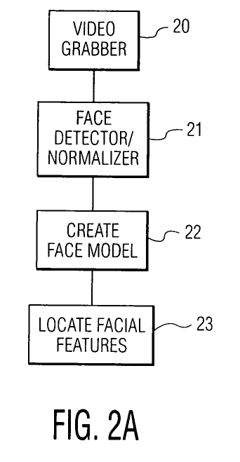

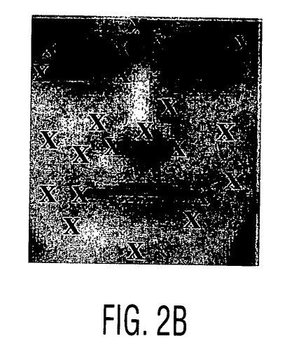

FIG. 2a shows an image capture device and facial feature locator. A video grabber 20 captures the image(s). The video grabber 20 can include any optical sensing device for converting images (visible light or infrared) to electrical images. Such devices include video camera, a monochrome camera, a color camera or cameras that are sensitive to non-visible portions of the spectrum such as infrared devices. The video grabber may also be realized as a variety of different types of video cameras or any suitable mechanism for capturing an image. The video grabber may also be an interface to a storage device that stores a variety of images. The output of the video grabber can for example be in the form of RGB, YUV, HIS or gray scale.

The imagery acquired via the video grabber 20 usually contains more than just a face. In order to locate the face within the imagery, the first and foremost step is to perform face detection. Face detection can be performed in various ways e.g. holistic based where the whole face is detected at one time or feature based where individual facial features are detected. Since the present invention is concerned with locating expressive parts of the face, the feature based approach is used to detect the interloccular distance between the eyes. An example of the feature-based face detection approach is described in “Detection and Tracking of Faces and Facial Features, by Antonio Colmenarez, Brendan Frey and Thomas Huang.” International Conference on Image Processing, Kobe, Japan, 1999 hereby incorporated by reference. It is often the case that instead of facing the camera the face may be rotated as the person whose image is being acquired might not be looking directly into the imaging device. Once the face is reoriented it will be resized. The Face Detector/Normalizer 21 normalizes the facial image to a preset N×N pixel array size, in a preferred embodiment this size is 64×72 pixels, so that the face within the image is approximately the same size as the other stored images. This is achieved by comparing the interloccular distance of the detected face with the interloccular distances of the stored faces. The detected face is then made larger or smaller depending on what the comparison reveals. The detector/normalizer 21 employs conventional processes known to one skilled in the art to characterize each detected facial image as a two dimensional image having an N by N array of intensity values.

The captured normalized images 22 are then sent to a face model creator 22. The face model creator 22 takes the detected normalized faces and creates a face model to identify the individual faces. Face models are created using Radial Basis Function (RBF) networks. Each face model is the same size as the detected facial image. A radial basis function network is a type of classifier device and it is described in commonly owned co-pending U.S. patent application Ser. No. 09/794,443 entitled “Classification of Objects through Model Ensembles,” filed Feb. 27, 2001, the whole contents and disclosure of which is hereby incorporated by reference as if fully set forth herein. Almost any classifier can be used to create the face models, such as Bayesian Networks, the Maximum Likelihood Distance Metric (ML) or the radial basis function network.

The Facial Feature Locator 23 locates facial features such as the beginning and ending of each eyebrow, eye beginning and end, nose tip, mouth beginning and end and additional features as shown in FIG. 2b. The facial features are located by either selecting the features by hand, or by using the ML distance metric as described in the paper “Detection and Tracking of Faces and Facial Features” by Antonio Colmenarez and Tomas Huang. Other methods of feature detection include optical flow methods. Depending on the system it may not be necessary to locate all facial features, but only the expressive facial features, which are likely to change as the expression on a person's face changes. The facial feature locator stores the locations of the facial features in the captured image. (It should be noted that the stored images are also in the form of face models and have had feature detection performed.)

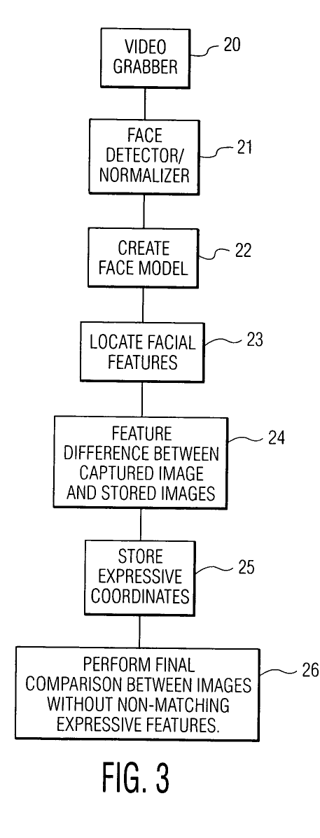

After the facial features have been found, facial identification and/or verification is performed. FIG. 3 shows a block diagram of a facial identification/verification system in accordance with a preferred embodiment of the invention. The system shown in FIG. 3 includes first and second stages. The first stage is as shown in FIG. 2a and is the capture device/facial feature locator. This stage includes the video grabber 20, which captures an image of a person the Face Detector/Normalizer 21 which normalizes the image the face model creator 22, and the facial feature locator 23. The second stage is a comparison stage for comparing the captured image to the stored images. This stage includes a feature difference detector 24, a storage device 25 for storing coordinates of non-matching features and a final comparison stage 26 for comparing the entire image minus the non-matching expressive features with the stored images.

The feature difference detector 24 compares the expressive features of the captured image with like facial features of the stored face models. Once the facial feature locator has located the coordinates for each feature, the feature difference detector 24 determines how different the facial feature of the captured image is from the like facial features of the stored images. This is performed by comparing the pixels of the expressive features in the captured image with the pixels of the like expressive features of the stored images.

The actual comparison between pixels is performed using the Euclidean distance. For two pixels p₁=[R₁ G₁ B₁] and p₂=[R₂ G₂ B₂] this distance is computed as
d=\sqrt{(R₁−R₂)²+(G₁−G₂)²+(B₁−B₂)²}

The smaller the d, the closer match between two pixels. The above assumes the pixels are in the RGB format. One skilled in the art could apply this same type of comparison to other pixel formats as well (e.g. YUV).

One should note that only non-matching features are removed from the overall comparison performed by comparator 26. If a particular feature matches a like feature in the stored image it is not considered an expressive feature and remains in the comparison. A match can mean within a certain tolerance limit.

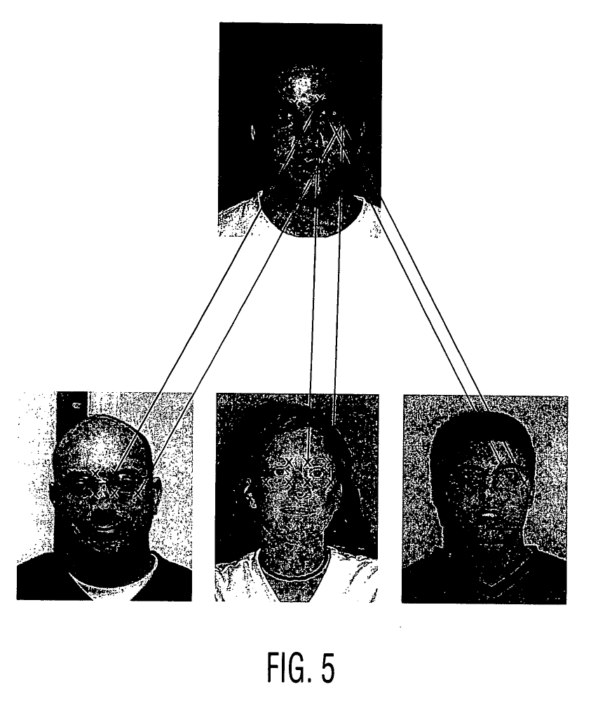

For example, the left eye of the captured image is compared with all of the left eyes of the stored images (FIG. 5). The comparison is performed by comparing the intensity values of the pixels of the eye within the N×N captured image with the intensity values of the pixels of the eyes of the N×N stored images. If there is no match between an expressive facial feature of the captured image and the corresponding expressive features in the stored images then the coordinates of the expressive features of the captured image are stored at 25. The fact that there is no match between an expressive facial feature of a captured image with the corresponding expressive facial features of the stored images could mean that the captured image does not match with any stored image or it could just mean that the eye in the captured image is closed whereas the eye in a matching stored image is open. Accordingly these expressive features do not need to be used in the overall image comparison.

Other expressive facial features are also compared and the coordinates of the expressive features that do not match with any corresponding expressive facial feature in the stored images are stored at 25. Comparator 26 then takes the captured image and subtracts the pixels that are within the stored coordinates of the expressive facial features with no match and only compares the non-expressive features of the captured image with the non-expressive features of the stored images to determine a probability of a match, and also compares the expressive facial features of the captured image that have a match with the expressive features of the stored image.

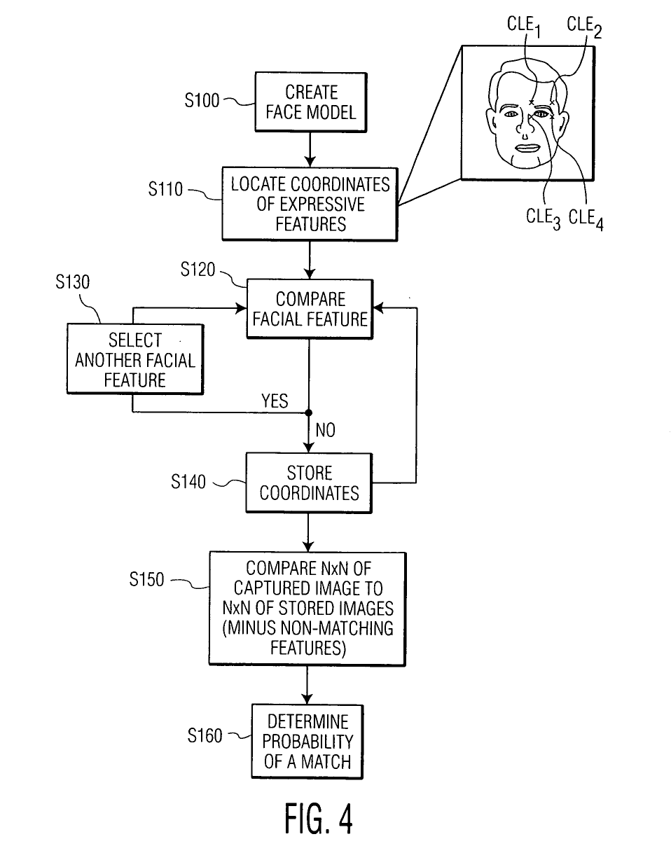

FIG. 4 shows a flow chart in accordance with a preferred embodiment of the invention. This flow chart explains the overall comparison that is performed between the captured image and the stored images. At step S100 a face model is created from the captured image and the location of the expressive features are found. The expressive features are, for example, the eyes, eyebrows, nose and mouth. All or some of these expressive features can be identified. The coordinates of the expressive features are then identified. As shown at 90 and at S110 the coordinates of the left eye of the captured image are found. These coordinates are denoted herein as CLE₁₋₄. Similar coordinates are found for the right eye CRE₁₋₄ and the mouth CM₁₋₄. At S120 a facial feature of the captured image is selected for comparison to the stored images. Assume the left eye is chosen. The pixels within the coordinates of the left eye CLE₁₋₄ are then compared at S120 with the corresponding pixels within the coordinates of the left eyes of the stored images (Sₙ LE₁₋₄). (See FIG. 5). If at S130 the pixels within the left eye coordinates of the captured image do not match the pixels within any of the left eye coordinates of the stored images then the coordinates CLE₁₋₄ of the left eye of the captured image are stored S140 and a next expressive facial feature is selected at S1120. If the pixels within the left eye coordinates of the captured image match S130 the pixels within the left eye coordinates of one of the stored images then the coordinates are not stored as “expressive” feature coordinates and another expressive facial feature is chosen at S120. It should be noted that the term match could mean a high probability of a match, a close match or an exact match. Once all expressive facial features are compared, then the N×N pixel array of the captured image (CN×N) is compared to the N×N arrays of the stored images (S₁N×N . . . SₙN×N). This comparison however is performed after excluding the pixels falling within any of the stored coordinates of the captured image (S150). If for example the person in the captured image is winking his left eye and in the stored image he is not winking then the comparison will probably be as follows:

((CN×N)−CLE₁₋₄) is compared to ((S₁N×N)−S₁LE₁₋₄) . . . (SₙN×N)−SₙLE₁₋₄))

This comparison results in a probability of a match with a stored image S160. By removing the non-matching expressive features (the winking left eye) the differences associated with open/closed eyes will not be part of the comparison and thereby reduces false negatives.

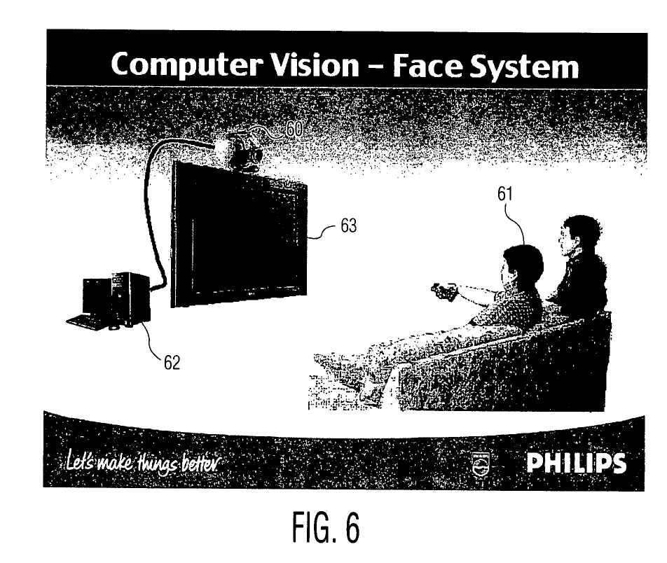

Those skilled in the art will appreciate that the face detection system of the present invention has particular utility in the area of security systems, and in-home networking systems where the user must be identified in order to set home preferences. The images of the various people in the house are stored. As the user walks into the room an image is captured and immediately compared to the stored images to determine the identification of the individual in the room. Since the person will be going about normal daily activities it can be easily understood how the facial expressions on the people as they enter a particular environment may be different than his/her facial features in the stored images. Similarly in a security application such as an airport the image of the person as he/she is checking in may be different than his/her image in the stored database. FIG. 6 shows an in-home networking system in accordance with the invention.

The imaging device is a digital camera 60 and it is located in a room such as the living room. As a person 61 sits in the sofa/chair the digital camera captures an image. The image is then compared using the present invention with the images stored in the database on the personal computer 62. Once identification is made, the channel on the television 63 is changed to his/her favorite channel and the computer 62 is set to his/her default web page.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method of comparing a captured image with stored images, comprising:
capturing a facial image that has expressive features;
locating the expressive features of the captured facial image;
comparing an expressive feature of the captured facial image with the like expressive feature of the stored images, and if there is no match with any like expressive feature of the stored images then marking the expressive feature as a marked expressive feature;
comparing: 1) the captured image, minus the marked expressive feature, with 2) the stored images minus the like expressive feature that corresponds to the marked expressive feature.

2. The method as claimed in claim 1, wherein the captured image is in the form of a face model and the stored images are in the form of face models.

3. The method as claimed in claim 1, wherein the locations of the expressive features are found using an optic flow technique.

4. The method as claimed in claim 2, wherein the face models are created using a classifier.

5. The method as claimed in claim 4, wherein the classifier is a neural network.

6. The method as claimed in claim 4, wherein the classifier is a Maximum-Likelihood distance metric.

7. The method as claimed in claim 4, wherein the classifier is a Bayesian Network.

8. The method as claimed in claim 4, wherein the classifier is a radial basis function.

9. The method as claimed in claim 1, wherein the steps of comparing compare the pixels within expressive feature of the captured image with the like pixels within the expressive feature of the stored images.

10. The method as claimed in claim 1, wherein the step of marking stores the coordinates of the non-matching expressive feature of the captured image.

11. A device for comparing pixels within a captured image with pixels within stored images, comprising:
a capturing device that captures a facial image having expressive features;
a facial feature locator which locates the expressive features of the captured facial image;
a comparator which compares the expressive features of the captured facial image with the like expressive features of the stored images, and if there is no match with any expressive feature of the stored images then marking the expressive feature of the captured image as a marked expressive feature;
the comparator also compares 1) the captured image, minus the marked expressive features, with 2) the stored images minus the like expressive feature that corresponds to the marked expressive feature.

12. The device as claimed in claim 11, wherein the captured image is in the form of a face model and the stored images are in the form of face models.

13. The device as claimed in claim 11, wherein the facial feature locator is a Maximum-Likelihood distance metric.

14. The device as claimed in claim 11, wherein the capturing device is a video grabber.

15. The device as claimed in claim 11, wherein the capturing device is a storage medium.

16. The device as claimed in claim 11, wherein the comparator compares the pixels within expressive feature of the captured image with the like pixels within the expressive feature of the stored images.

17. The device as claimed is claim 11 further including a storage device which marks the expressive feature by storing the coordinates of the non-matching expressive feature of the captured image.

18. A device for comparing pixels within a captured image with pixels within stored images, comprising:
capturing means for capturing a facial image that has expressive features;
facial feature locating means for locating the expressive features of the captured facial image;
comparing means which compare the pixels within the expressive features of the captured facial image with the pixels within the expressive features of the stored images, and if there is no match with any expressive feature of the stored images then storing in a memory the location of the expressive feature of the captured image;
the comparing means also for comparing 1) the pixels within the captured image, minus the pixels within the location of the non-matching expressive features, with 2) the pixels within the stored images minus the pixels within the location of the non-matching expressive features.

19. The device in accordance with claim 18, wherein the images are stored as face models.

20. The device in accordance with claim 18, wherein the locator is a maximum likelihood distance metric.

21. The device in accordance with claim 19, wherein the face models are created using radial basis functions.

22. The device in accordance with claim 19, wherein the face models are created using Bayesian networks.

23. A face detection system, comprising:
a capturing device that captures a facial image that has expressive features;
a facial feature locator which locates the expressive features of the captured facial image;
a comparator which compares the pixels within the expressive features of the captured facial image with the pixels within the expressive features of the stored images, and if there is no match with any expressive feature of the stored images then storing in a memory the location of the expressive feature of the captured image;
the comparator also compares 1) the captured image, minus the location of the non-matching expressive features, with 2) the stored images minus the coordinates of the non-matching expressive features.
